(19) United States
(12) Patent Application Publication
(10) Pub. No.: US 2006/0283184 A1
(43) Pub. Date: Dec. 21, 2006

(54) Pressure compensating flow control hydraulic circuit having holding valve

(75) Inventor: Hae Kyun Cheong, Pusan (KR)

Correspondence Address: LADAS & PARRY, 26 WEST 61ST STREET, NEW YORK, NY, 10023, US

(73) Assignee: VOLVO CONSTRUCTION EQUIPMENT HOLDING SWEDEN AB.

(21) Appl. No.: 11/402,770

(22) Filed: Apr. 12, 2006

(30) Foreign Application Priority Data
Jun. 17, 2005 (KR) 10-2005-0052313

(51) Int. Cl. F16D 31/02

(52) U.S. Cl. 60/486

(57) ABSTRACT

A pressure compensating flow control hydraulic circuit having a holding valve is disclosed. The pressure compensating flow control hydraulic circuit can perform the function of a holding valve so as to prevent the naturally lowering phenomenon of a working unit due to the leakage of a hydraulic fluid when the working unit is located in a neutral position, and can perform the function of a flow control valve when the working unit is operated. The pressure compensating flow control hydraulic circuit includes first and second hydraulic pumps; a boom cylinder for being supplied with a hydraulic fluid from the first hydraulic pump when a control valve of the boom cylinder is switched over; an arm cylinder for being supplied with the hydraulic fluid from the second hydraulic pump when a control valve is of the arm cylinder is switched over; a holding valve for preventing an arm from being naturally lowered due to a load pressure; an auxiliary spool for being switched over in response to a pilot signal applied from an outside to release a load of the arm cylinder; and a flow control valve for controlling a flow rate of the hydraulic fluid to drain from the small chamber of the arm cylinder to the hydraulic tank constantly when the auxiliary spool is switched over.

### CROSS-REFFERENCE TO BE RELATED APPLICATIONS

This application claims benefits under 35 U.S.C.§119 from Korea Patent Application No. 2005-52313, filed on Jun. 17, 2005, the entire content of which is incorporated herein by reference.

### BACKGROUND OF THE INVENTION

1. Field of the Invention

The present invention relates to a pressure compensating flow control hydraulic circuit having a holding valve, which can evenly maintain an operation speed of a working unit at the same pilot signal pressure irrespective of a load pressure of a working unit such as a boom, an arm, or the like.

More particularly, the present invention relates to a pressure compensating hydraulic circuit having a holding valve which can perform an inherent function of the holding valve that prevents a naturally lowering phenomenon of a working unit due to the leakage of a hydraulic fluid of a working unit when the working unit is located in a neutral position, and perform a function of a flow control valve when the working unit is operated.

2. Description of the Prior Art

FIG. 1 is a side view of a general wheel type excavator or power shovel.

As shown in FIG. 1, the wheel type power shovel includes a lower traveling body 1 driven by a traveling motor, an upper swivel [swing] body 3, mounted on the lower traveling body, for swing about a vertical axis on the lower traveling body, and having a operation room 2 mounted thereon, a boom 5 pivotally connected to the front side of the upper swing body 3, an arm 7 connected to the front end of the boom 5 and pivoted by the operation of an arm cylinder 6, and a bucket 9 connected to the front end of the arm 7 and pivoted by the operation of a bucket cylinder 8.

The power shovel performs excavation and load by operating the working unit, such as the boom, arm, and bucket. In this case, some of hydraulic fluid in a hydraulic hose for connecting a hydraulic cylinder and a flow control valve is leaked through a gap between a spool and a housing of the flow control valve due to the weight of the massive working unit and the load of materials to be loaded. For the reason, when the working unit is in a neutral position, it becomes naturally lowered or dropped due to the leakage of the hydraulic fluid. Therefore, a hydraulic system fixed to the heavy construction equipment such as the power shovel includes a holding valve that prevents the natural drop due to load in neutral position of a working unit from occurring.

FIG. 2 is a view illustrating a conventional hydraulic circuit having a holding valve.

As shown in FIG. 2, the hydraulic circuit includes first and second variable displacement hydraulic pumps 10 and 11, actuators (i.e., a left traveling motor 15, a bucket cylinder 16, and a boom cylinder 17), connected to the first hydraulic pump 10, for operating by the supply of the hydraulic fluid thereto when control valves 12, 13, and 14 are switched over, actuators (i.e., a right traveling motor 21, an arm cylinder 22, and a swing motor 23), connected to the second hydraulic pump 11, for operating by the supply of the hydraulic fluid thereto when control valves 18, 19, and 20 are switched over, a holding valve 24, disposed between the control valve 19 of the arm cylinder and a small chamber 22a of the actuator (i.e., the arm cylinder) 22, for preventing the working unit from being lowered due to the load pressure caused by the weight of the working unit itself, and an auxiliary spool 25 for being switched over in response to a pilot signal applied from an outside and releasing the load of the actuator 22.

The holding valve 24 may be installed in the flow path of the boom cylinder 17 so as to prevent the boom from being lowered or dropped.

An arm-out operation is performed as follows. If a driver manipulates a remote control valve (RCV), which is not shown in the drawing, a pilot signal is applied to the left end of the control valve 19 to cause an internal spool to shift rightward on the drawing. Consequently, the hydraulic fluid discharged from the second hydraulic pump 11 is fed to the small chamber 22a of the actuator 22 through the control valve 19 of the arm cylinder and the holding valve 24, and thus the actuator is contracted to perform the arm-out operation.

In this case, a control area of the control valve 19 is varied to adjust the operation speed (i.e., the driving speed of the arm) according to a shift amount of the spool in the control valve 19. The hydraulic fluid discharged from the large chamber 22b of the actuator 22 drains to a hydraulic tank through the control valve 19.

An arm-in operation is performed as follow. If the driver manipulates the remote control valve (RCV), which is not shown in the drawings, a pilot signal is applied to the right end of the control valve 19 of the arm cylinder to cause the internal spool to shift leftward on the drawing, as shown in FIG. 2. Simultaneously, the pilot signal is applied to the auxiliary spool 25 to cause the auxiliary spool 25 to shift leftward on the drawing.

Consequently, the hydraulic fluid discharged from the second hydraulic pump 11 is fed to the large chamber 22b of the actuator 22 through the control valve 19, so that the actuator is stretched to perform the arm-in operation. In this case, the hydraulic fluid discharged from the small chamber 22a of the actuator 22 drains to the hydraulic tank through the orifice 24a and a back pressure chamber of the holding valve 24, the auxiliary spool 25, and the control valve 19 in order.

In this case, when the hydraulic fluid flowing through the actuator 22 is returned to the hydraulic tank, a pressure loss occurs in the orifice 24a of the holding valve 24, and thus the pressure conducted through the orifice 24a becomes lower than that before the pressure is conducted through the orifice 24a. Therefore, the holding valve 24 moves upward on the drawing, so that the hydraulic fluid in the small chamber 22a of the actuator 22 drains to the hydraulic tank through the holding valve 24 and the control valve 19.

The orifice 19a provided in the control valve 19 prevents the arm-in operation from being speedily performed due to the load pressure.

According to the conventional pressure compensating flow control hydraulic circuit having the holding valve as described above, since an amount of the hydraulic fluid discharged from the actuator 22 to the hydraulic tank is unevenly varied by the load pressure due to the weight of the arm and the load of the materials to be loaded, the driving speed of the arm is also varied severely. Thus, in the case of performing the composite operation in which the arm is manipulated together with the working unit such as the boom or the swing motor, it is difficult to harmonize the driving speed of the arm with the driving speed of the working unit such as the boom or the swing motor, thereby reducing its workability and manipulation.

That is, in the case where another optional unit (e.g., a brake) is installed instead of the bucket of the standard working unit of a heavy construction equipment, or actual working is performed, the load pressure is varied. For example, if the weight of the working unit is increased while the heavy construction equipment is operated, the pressure in the small chamber of the arm cylinder and the pressure in the large chamber of the boom cylinder are increased.

The flow rate of the oil fed to the actuator is as follows.
Flow rate Q=Cd×A×(ΔP)^{1/2}
where, Q denotes a flow rate, Cd denotes a flow coefficient, A denotes an orifice area of the spool of the control valve, and ΔP denotes a pressure difference between an input pressure and an output pressure in the orifice area.

According to the above equation, even if the same pilot signal is applied to the control valve, ΔP is variable, and thus the operation speed of the working unit (i.e., the driving speed of the arm) is varied.

### SUMMARY OF THE INVENTION

Accordingly, the present invention has been made to solve the above-mentioned problems occurring in the prior art, and an object of the present invention is to provide a pressure compensating hydraulic circuit having a holding valve which can perform the function of a holding valve so as to prevent the naturally lowering phenomenon of a working unit due to the leakage of a hydraulic fluid when the working unit is located in a neutral position, and can perform the function of a flow control valve when the working unit is operated.

Another object of the present invention is to provide a pressure compensating flow control hydraulic circuit having a holding valve which can maintain an even operation speed at the same pilot signal pressure, irrespective of the load pressure of an actuator, thereby easily manipulating construction heavy equipment.

Still another object of the present invention is to provide a pressure compensating flow control hydraulic circuit having a holding valve, which can be simplified with compact components, and thus its manufacturing cost can be reduced.

In order to accomplish these objects, there is provided a pressure compensating flow control hydraulic circuit having a holding valve, which comprises first and second hydraulic pumps; a boom cylinder, connected to the first hydraulic pump, for being supplied with a hydraulic fluid from the first hydraulic pump when a control valve of the boom cylinder is switched over; an arm cylinder, connected to the second hydraulic pump, for being supplied with the hydraulic fluid from the second hydraulic pump when a control valve is of the arm cylinder is switched over; a holding valve, disposed on any one of a flow path between the control valve of the arm cylinder and the arm cylinder and a flow path between the control valve of the boom cylinder and the boom cylinder, for preventing an arm from being naturally lowered due to a load pressure; an auxiliary spool, disposed at a downstream side of the holding valve, for being switched over in response to a pilot signal applied from an outside to release a load of the arm cylinder; and a flow control valve, interposed between an upstream line of the holding valve and a downstream line of the auxiliary spool, for controlling a flow rate of the hydraulic fluid to drain from the small chamber of the arm cylinder to the hydraulic tank constantly when the auxiliary spool is switched over.

The flow control valve may include a first chamber having an orifice for reducing an orifice area of the flow control valve when a flow rate of the hydraulic fluid flowing through the holding valve is increased to cause the pressure to be increased; and a second chamber for increasing the orifice area of the flow control valve when the flow rate of the hydraulic fluid flowing through the holding valve is decreased to cause the pressure to be reduced.

### BRIEF DESCRIPTION OF THE DRAWINGS

The above and other objects, features and advantages of the present invention will be more apparent from the following detailed description taken in conjunction with the accompanying drawings, in which:

FIG. 1 is a side view of a general wheel type excavator or power shovel;

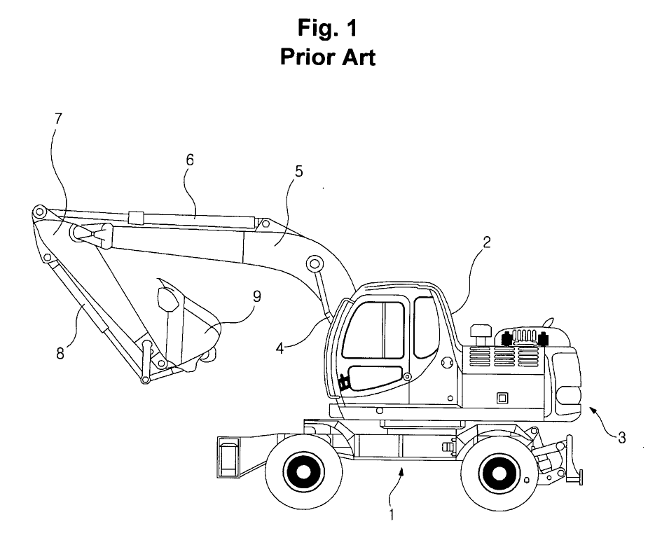

FIG. 2 is a view illustrating a conventional hydraulic circuit having a holding valve; and

FIG. 3 is a diagram illustrating a hydraulic circuit having a holding valve according to the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

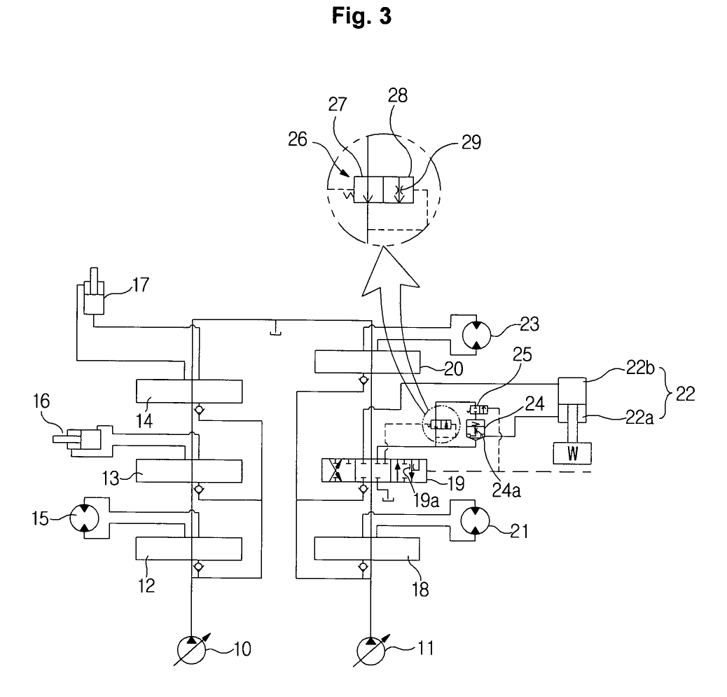

With reference to FIG. 3, a preferred embodiment of the present invention will now be explained.

As shown in FIG. 3, a pressure compensating hydraulic circuit having a holding valve according to the present invention includes first and second variable displacement hydraulic pumps 10 and 11; a traveling motor 15, a bucket cylinder 16, and a boom cylinder 17, which are respectively connected to the first variable displacement hydraulic pump 10 and are supplied with a hydraulic fluid from the first hydraulic pump 10 when control valves 12, 13, and 14 are switched over in response to a pilot signal applied from an outside; a traveling motor 21, an arm cylinder 22, and a swing motor 23, which are respectively connected to the second variable displacement hydraulic pump 11 and are supplied with a hydraulic fluid from the second hydraulic pump 11 when the control valves 12, 13, and 14 are switched over in response to the pilot signal applied from the outside; a holding valve 24, interposed between the control valve 19 of the arm cylinder and the small chamber 22a of the arm cylinder 22, for preventing an arm from being naturally lowered due to a load pressure applied to the arm cylinder 22 and a weight of a working unit; an auxiliary spool 25, disposed at the downstream side of the holding valve 24, for being switched over in response to the pilot signal applied from the outside to release the load of the arm cylinder (i.e., a check valve function of the holding valve is released); and a flow control valve 26, interposed between the upstream line of the holding valve 24 and the downstream line of the auxiliary spool 25, for controlling a flow rate of the hydraulic fluid to drain from the small chamber 22a of the arm cylinder 22 to the hydraulic tank constantly when the auxiliary spool 25 is switched over in response to the applied pilot signal.

The flow control valve 26 includes a first chamber 28 for reducing the orifice area of the flow control valve 26 using an orifice when a flow rate of the hydraulic fluid flowing through the holding valve 24 is increased to cause pressure to be increased, and a second chamber 27 for increasing the orifice area of the flow control valve 26 when the flow rate of the hydraulic fluid flowing through the holding valve 24 is decreased to cause the pressure to be reduced.

The holding valve 24 may be installed in the boom cylinder 17 to prevent the boom from being lowered.

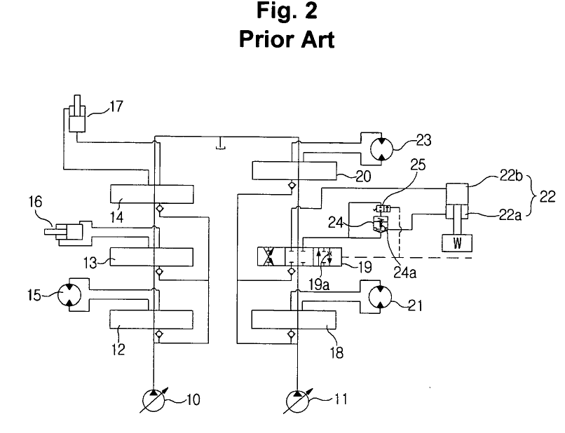

In the following description of the present invention, the same reference numerals are used to designate the substantially same components as those of the conventional circuit of FIG. 2.

An example of the hydraulic circuit having the holding valve according to the present invention will now be described in detail with reference to FIG. 3.

A case where the pilot signal is not applied and thus the working unit is a neutral position will now be described.

As shown in FIG. 3, when the load pressure acting on the small chamber 22a of the arm cylinder 22 is applied to the back pressure chamber of the holding valve 24, the holding valve 24 is maintained in a closed state, and the auxiliary spool 25 is also maintained in a block state, as shown in FIG. 3, due to a cross-sectional difference of the holding valve 24. Accordingly, the hydraulic fluid is prevented from draining from the small chamber 22a of the arm cylinder 22 to the hydraulic chamber.

Consequently, the arm is prevented from being naturally lowered by the load pressure occurring due to the weight of the arm and the load of the material to be loaded.

A case where the pilot signal is applied and thus the working unit is operated will now be described.

As shown in FIG. 3, when the pilot signal is applied to the right end of the control valve 19 of the arm cylinder from an outside, the internal spool is shifted leftward on the drawing. Simultaneously, since the pilot signal is applied to the right end of the auxiliary spool 25, the auxiliary spool 25 is shifted leftward on the drawing. Accordingly, the hydraulic fluid discharged from the second hydraulic pump 11 is fed to the large chamber 22b of the arm cylinder 22 through the control valve 19. In this case, the hydraulic fluid discharged from the small chamber 22a of the arm cylinder 22 drains to the hydraulic tank through the holding valve 24.

If the flow rate of the hydraulic fluid flowing through the holding valve 24 is increased to cause the pressure to be increased, the increased pressure is applied to the right end of the flow control valve 26 as a signal along a signal line, so that the flow control valve 26 is moved leftward on the drawing. As the orifice area of the spool of the flow control valve 26 is reduced by the orifice 29 provided in the first chamber 28, the pressure in the back pressure chamber of the holding valve 24 is increased. Accordingly, the holding valve 24 is moved in a closing direction, i.e., downward on the drawing, so that the flow rate of the hydraulic fluid passing through the holding valve 24 is reduced.

By contrast, if the flow rate of the hydraulic fluid flowing through the holding valve 24 is decreased to cause the pressure to be reduced, the flow control valve 26 is moved to the second chamber 27 by the reduced pressure, which is shown in the drawing. As the orifice area of the spool of the flow control valve 26 is increased, the pressure in the back pressure chamber of the holding valve 24 is reduced. Accordingly, the holding valve 24 is moved in an opening direction, i.e., upward on the drawing, so that the flow rate of the hydraulic fluid passing through the holding valve 24 is increased.

Therefore, when the arm-in operation of the arm cylinder 22 is performed, the hydraulic fluid discharged from the small chamber 22a of the arm cylinder and flowing through the holding valve can be controlled at a constant flow rate, irrespective of the load pressure occurring in the arm cylinder 22. Specifically, the flow rate of the hydraulic fluid discharged from the arm cylinder 22 to the hydraulic tank can be controlled in accordance with the pilot signal applied to the control valve 19 of the arm cylinder 22, irrespective of the load pressure occurring in the arm cylinder 22.

As described above, the pressure compensating flow control hydraulic circuit having the holding valve according to the present invention has the following advantages.

The pressure compensating flow control hydraulic circuit can perform the function of the holding valve to prevent the naturally lowering phenomenon of the working unit due to the leakage of the hydraulic fluid when the working unit is in a neutral position, and can perform the function of the flow control valve when the working unit is operated.

Further, the pressure compensating flow control hydraulic circuit can maintain an even operation speed at the same pilot pressure, irrespective of the load pressure of an actuator, thereby easily manipulating the construction heavy equipment.

Furthermore, the pressure compensating flow control hydraulic circuit can be simplified with compact components, and thus its manufacturing cost can be reduced.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A pressure compensating flow control hydraulic circuit having a holding valve, comprising:
first and second hydraulic pumps;
a boom cylinder, connected to the first hydraulic pump, for being supplied with a hydraulic fluid from the first hydraulic pump when a control valve of the boom cylinder is switched over;
an arm cylinder, connected to the second hydraulic pump, for being supplied with the hydraulic fluid from the second hydraulic pump when a control valve is of the arm cylinder is switched over;
a holding valve, disposed on any one of a flow path between the control valve of the arm cylinder and the arm cylinder and a flow path between the control valve of the boom cylinder and the boom cylinder, for preventing an arm from being naturally lowered due to a load pressure;
an auxiliary spool, disposed at a downstream side of the holding valve, for being switched over in response to a pilot signal applied from an outside to release a load of the arm cylinder; and
a flow control valve, interposed between an upstream line of the holding valve and a downstream line of the auxiliary spool, for controlling a flow rate of the hydraulic fluid to drain from the small chamber of the arm cylinder to the hydraulic tank constantly when the auxiliary spool is switched over.

2. The pressure compensating flow control hydraulic circuit as claimed in claim 1, wherein the flow control valve comprises:
a first chamber having an orifice for reducing an orifice area of the flow control valve when a flow rate of the hydraulic fluid flowing through the holding valve is increased to cause pressure to be increased; and
a second chamber for increasing the orifice area of the flow control valve when the flow rate of the hydraulic fluid flowing through the holding valve is decreased to cause the pressure to be reduced.
